(19) United States
(12) Patent Application Publication
(10) Pub. No.: US 2007/0061861 A1
(43) Pub. Date: Mar. 15, 2007

(54) Device, system, and method of discriminately handling a wideband transmission in a communication network

(76) Inventors: Yeshayahu Strull, Tel Aviv (IL); Olga Degtyarev, Lod (IL); Yossi Meiri, Tel Aviv (IL)

Correspondence Address: PEARL COHEN ZEDEK, LLP;PEARL COHEN ZEDEK LATZER, LLP, 1500 BROADWAY 12TH FLOOR, NEW YORK, NY, 10036, US

(21) Appl. No.: 11/223,102

(22) Filed: Sep. 12, 2005

(51) Int. Cl. H04N 7/173

(52) U.S. Cl. 725/118; 725/117

(57) ABSTRACT

Embodiments of the invention provide a method, device and system of discriminately handling a wideband transmission including a legacy frequency signal of a legacy frequency band and an extended frequency signal of an extended frequency band. In some demonstrative embodiments a signal discrimination device includes a signal adjustment module to generate an adjusted signal corresponding to the legacy frequency signal; a first multiplexer to selectively route the legacy frequency signal from a first terminal of the signal discrimination device to the signal adjustment module; and a second multiplexer to selectively route the adjusted signal to a second terminal of the signal discrimination device, wherein the first multiplexer is able to selectively route an extended frequency signal of the extended frequency band from the first terminal to the second multiplexer, and wherein the second multiplexer is able to selectively route the extended signal to the second terminal. Other embodiments are described and claimed.

### FIELD OF THE INVENTION

The present invention relates generally to devices, systems, and methods for expanding the operational bandwidth of a cable television network and, more particularly, to devices, systems, and methods of discriminately handling a wideband transmission in the cable television network.

### BACKGROUND OF THE INVENTION

Cable television (CATV) is a form of broadcasting that distributes programs of information to paying subscribers via a physical infrastructure of coaxial cables and/or a combination of coaxial cables and fiber-optic cables. A CATV network may maintain a direct physical link between a transmission center, such as a head-end, and a plurality of subscribers, such as homes and/or businesses, that may include subscribers located at addressable remote locations. A conventional CATV network may provide the subscribers with distribution services of information such as FM radio signals, multi-channel TV programs, videotext, and the like, and in some cases limited two way information services, such as pay-per-view and video-on-demand.

Recently, subscribers have shown increased demand for broadband interactive data services. An interactive data service may include, for example, a two-way access service to established data networks, such as an Internet and/or Intranet. The increased demand and requirement for faster two-way data access service, i.e., for downloading and/or uploading data information, particularly graphics related data information such as movies, have brought the bandwidth constraint issue in the conventional CATV network into focus. This bandwidth constraint is related to a limitation on the usable frequency range available for signal transmission in the conventional CATV network. Due to various practical limitations related to the design, engineering, and manufacturing of the conventional cables and components, which constitute most of the current cable plant infrastructure, existing broadcasting technologies generally do not allow signal transmission in a frequency range beyond 1 GHz, or 860 MHz, or even 750 MHz.

In order to provide faster data access services through the conventional CATV network, the signal transferring capacity of the conventional network may need to be substantially increased.

When propagating through a coaxial cable of a CATV network, electronic signals may experience losses in signal power. In most cases, the losses may be frequency dependent due to loss properties, which may be inherent to the coaxial cable. Signals of different frequencies may have different power levels, e.g., due to different insertion losses after propagating through a certain length of cable. Radio frequency (RF) amplifiers may be applied to compensate the signal powers. An RF amplifier may usually provide a certain amount of gain to signals in a certain bandwidth. However, it may not be feasible to provide different gains to signals of different frequencies. Thus, it may be difficult to boost the power of signals of different frequencies to substantially even levels.

### SUMMARY OF DEMONSTRATIVE EMBODIMENTS OF THE INVENTION

Some demonstrative embodiments of the present invention include a method, device and system of discriminately handling a wideband transmission including a legacy frequency signal of a legacy frequency band and an extended frequency signal of an extended frequency band.

In some demonstrative embodiments of the invention, a method of discriminately handling the wideband transmission may include receiving the wideband transmission; selectively adjusting the legacy frequency signal to generate an adjusted legacy frequency signal; and routing the adjusted legacy frequency signal and the extended frequency signal to said network.

Some demonstrative embodiments of the invention include a wideband CATV network supporting signals of the legacy frequency band and the extended frequency band. The network may include at least one signal discrimination device.

In some demonstrative embodiments of the invention the signal discrimination device may include first and second terminals; a signal adjustment module to generate an adjusted signal corresponding to the legacy frequency signal; a first multiplexer to route the legacy frequency signal from the first terminal to the signal adjustment module; and a second multiplexer to route the adjusted signal to the second terminal, wherein the first multiplexer is able to route the extended frequency signal of the extended frequency band from the first terminal to the second multiplexer, and wherein the second multiplexer is able to route the extended frequency signal to the second terminal.

In some demonstrative embodiments of the invention the first multiplexer may route an AC power signal from the first terminal to the signal adjustment module. The signal adjustment module may include one or more RF chokes to selectively route the AC power signal to the second multiplexer. The second multiplexer may route the AC power signal from the signal adjustment module to the second terminal.

In some demonstrative embodiments of the invention at least one of the first and second multiplexers may include a low-pass filter to selectively transfer the legacy frequency signal; and a high-pass filter to selectively transfer the extended frequency signal.

In some demonstrative embodiments of the invention the signal adjustment module may include a compensator to compensate a power loss of the legacy frequency signal. The compensator may include, for example, an equalizer to generate an equalized downstream signal corresponding to a legacy downstream signal of the legacy frequency band, and/or an attenuator to generate an attenuated upstream signal corresponding to a legacy upstream signal of the legacy frequency band; a third multiplexer to route the legacy downstream signal from the first multiplexer to the equalizer, and/or to route the attenuated upstream signal from the attenuator to the first multiplexer; and a fourth multiplexer to route the equalized downstream signal from the equalizer to the second multiplexer, and/or to route the legacy upstream signal from the second multiplexer to the attenuator.

In some demonstrative embodiments of the invention, the signal discrimination device may enable extending the data transmission capacity of the CATV network to include a frequency bandwidth of, for example, about 3 GHz, 4 GHz, or even 6 GHz or more.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings in which:

FIG. 1 is a simplified block diagram illustration of a wideband Cable Television (CATV) network including one or more signal discrimination devices in accordance with some demonstrative embodiments of the invention;

FIG. 2 is a block diagram illustration of a signal discrimination device in accordance with some demonstrative embodiments of the invention;

FIG. 3 is a schematic illustration of a circuit implementation of the signal discrimination device of FIG. 2, in accordance with some demonstrative embodiments of the invention; and

FIG. 4 is a block diagram illustration of a method of discriminately handling a wideband transmission of a cable communication network, in accordance with some demonstrative embodiments of the invention.

It will be appreciated that for simplicity and clarity of illustration, elements shown in the drawings have not necessarily been drawn accurately or to scale. For example, the dimensions of some of the elements may be exaggerated relative to other elements for clarity and/or several physical components may be included in one functional block or element. Further, where considered appropriate, reference numerals may be repeated among the drawings to indicate corresponding or analogous elements. Moreover, some of the blocks depicted in the drawings may be combined into a single function.

### DETAILED DESCRIPTION OF THE INVENTION

In the following detailed description, numerous specific details are set forth in order to provide a thorough understanding of the invention. However, it will be understood by those of ordinary skill in the art that the present invention may be practiced without these specific details. In other instances, well-known methods, procedures, components and circuits may not have been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

The terms “signals”, “data” and/or “data signals” as used throughout this application may refer to analog or digital signals, including video, audio and/or any other form of data representing information. Information to be transferred from a transmission center of a Cable Television (CATV) network to one or more subscribers, and/or from the subscribers to the transmission center, may be modulated, for example, onto radio frequency carriers and/or optical carriers. Any desired modulation method may be used, e.g., frequency modulation. The modulated carriers may be routed to/from the transmission center, for example, via cable transmission lines, and/or optic fiber lines. In addition to television programs and data network packets, signals transmitted within the CATV network may include other types of information such as video-on-demand. In some embodiments of the present invention, the CATV network may include, or may be part of a satellite communication system, a cellular network, and/or any other communication infrastructure that are operative in connecting diverse communication nodes located at remote locations.

Some embodiments of a wideband CATV network system, supporting a wide frequency band including a legacy frequency band and an extended frequency band, are described in U.S. patent application Ser. No. 09/830,015, filed Jul. 20, 2001, entitled “System and method for expanding the operative bandwidth of a cable television communication system”, and published Nov. 21, 2002 as US Publication Number US2002/0174435 (Reference 1), and in International Patent Application PCT/IL00/00655, filed Oct. 16, 2000, entitled “System and method for expanding the operative bandwidth of a cable television communication system”, and published Apr. 25, 2002 as International Publication number WO02/33968 (Reference 2). The disclosures of all of the above mentioned applications are incorporated herein by reference in their entirety.

Some demonstrative embodiments of the invention include devices, systems, and/or methods of adjusting losses of signals across a wide frequency band. This may enable, using amplifiers, for example, to boost signal power levels, e.g., relatively efficiently. The boost in signal power levels may enhance the performance of signals, which may be measured, for example, by a signal-to-noise (SNR) ratio. Such signal performance enhancement may extend the reach of cable networks, by enabling the delivery of the signals to remote sites and/or subscribers.

Some demonstrative embodiments of the invention may enable a CATV network to provide information distribution services at multi-gigabit data transmission speed.

Some demonstrative embodiments of the invention may be implemented to improve performance of a conventional CATV network by expanding the operational bandwidth of the network, for example, from a frequency bandwidth of approximately 860 MHz to a bandwidth of more than 1 GHz, e.g., a bandwidth of approximately 3 GHz, 4 GHz, or even 6 GHz or more. Such expansion of bandwidth may be accomplished by the addition of new advanced network components to the network and/or by the enhancement of existing network components, e.g., without requiring expensive replacement of existing coaxial cable infrastructure.

Some demonstrative embodiments of the invention may include devices, systems, and methods of discriminately handling signals in a wideband distribution network, which may support a wide frequency band of, for example, 5 MHz-3 GHz. In some demonstrative embodiments, discriminately handling the signals, may include adjusting legacy frequency signals of the legacy frequency band, e.g., as described in detail below.

In some demonstrative embodiments of the invention described herein, the term “wide frequency band” may refer to an exemplary frequency range of, e.g., 5 MHz-3 GHz; the term “legacy frequency band” may refer to an exemplary frequency range of 5-860 MHz; the term “legacy upstream frequency band” may refer to an exemplary frequency range of 5-42 MHz or 5-65 MHz; the term “legacy downstream frequency band” may refer to an exemplary frequency range of 54-860 MHz; and the term “extended frequency band” may refer to an exemplary frequency range of 1-3 GHz. However, it will be appreciated by those skilled in the art that in other embodiments of the invention, these frequency bands of exemplary frequency ranges may be replaced with other suitable frequency ranges. For example, embodiments of the invention may be adapted for a wide frequency band of beyond 5 MHz-3 GHz, e.g., 5 MHz-6 GHz or more, and/or for a legacy frequency band of 5 MHz-1 GHz.

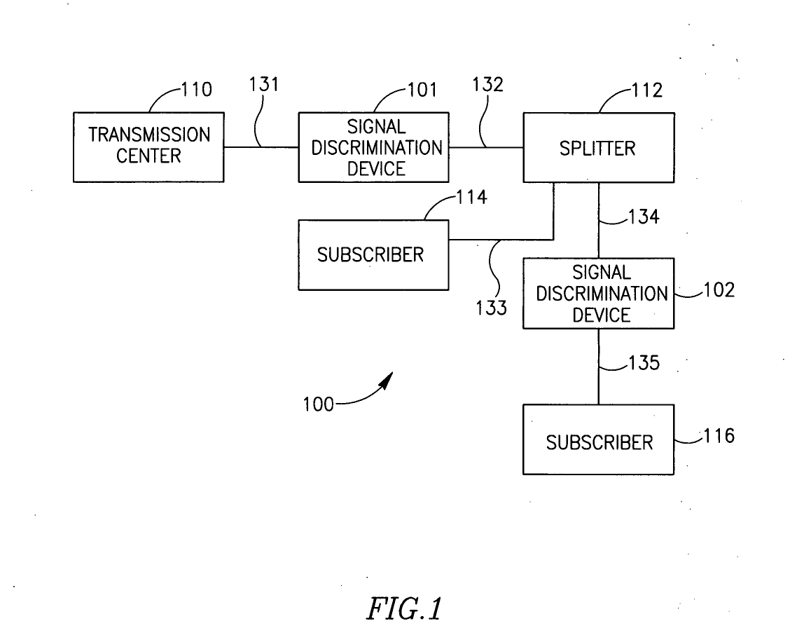

Reference is made to FIG. 1, which schematically illustrates a wideband CATV network 100 in accordance with some demonstrative embodiments of the invention.

According to some demonstrative embodiments of the invention, network 100 may include a transmission center 110; a splitter 112; and one or more subscribers, for example, subscribers 114 and 116. Network 100 may also include one or more signal discrimination devices, for example, signal discrimination devices 101 and 102.

In some demonstrative embodiments of the invention, signal discrimination devices 101 and/or 102 may include a signal adjustment module. The signal adjustment module may comprise, and/or may be a wideband compensator, e.g., as described below. However, it will be appreciated by those of ordinary skill in the art, that the invention is not limited in this respect. In other embodiments of the invention, the signal adjustment module may include, and/or may be any other suitable signal adjustment modules. For example, the signal adjustment module may include, and/or may be a wideband filter able to filter the legacy frequency signals.

Devices 101 and/or 102 may be positioned at different locations across network 100, e.g., based on any desired criteria. For example, one or more devices 101 and 102 may be located at predetermined distances from each other and/or from one or more elements of network 100.

Network 100 may optionally include other suitable CATV network components, units, modules and/or network elements, such as, for example, RF amplifiers, taps and/or diplexers, e.g., as described in References 1 and/or 2, which are not shown in FIG. 1 for the sake of clarity. For example, in one demonstrative embodiment of the invention, network 100 may include a Hybrid Fiber Coaxial (HFC) CATV network, e.g., including an optical fiber section.

According to some demonstrative embodiments of the invention, transmission center 110 may include a bead-end or a hub station. Transmission center 110 may broadcast information signals (hereinafter also referred to as “downstream signals”) to one or more subscribers, e.g., subscribers 114 and/or 116, for example, via a coaxial cable infrastructure, e.g., coaxial cables 131, 132, 133 134, and/or 135. In other embodiments of the invention, network 100 may include any other suitable configuration, e.g., an HFC configuration, for transferring information signals from center 110 to subscribers 114 and/or 116. Subscribers 114 and/or 116, may transfer information signals (also referred to herein as “upstream signals”), which may include, for example, video-on-demand signals and/or web page data being uploaded, to transmission center 110 via cables 131, 132, 133, 134, and/or 135. Devices 101 and/or 102 may selectively adjust, e.g., provide loss compensation, to the upstream and/or downstream signals, e.g., as described in detail below.

It will be appreciated by persons skilled in the art that network 100 may incorporate any desirable arrangement of the one or more signal discrimination devices, e.g., an arrangement different from the configuration shown in FIG. 1. In addition, in other embodiments network may include a larger/smaller number of signal discrimination devices.

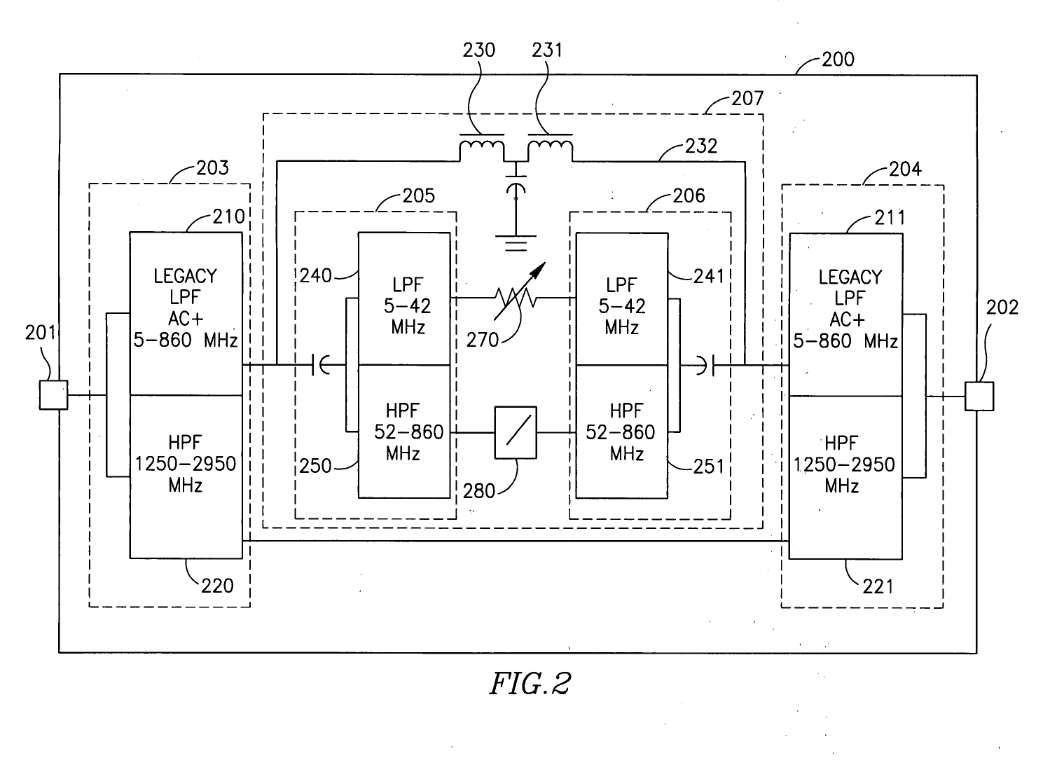

Reference is now made to FIG. 2, which schematically illustrates a signal discrimination device 200 in accordance with some demonstrative embodiments of the invention. Although the invention is not limited in this respect, signal discrimination device 200 may perform the functionality of device 101 and/or device 102 (FIG. 1).

According to some demonstrative embodiments of the invention, signal discrimination device 200 may include a first terminal 201, and a second terminal 202, which may be adapted, for example, for connecting module 200 into a CATV network, e.g., network 100 (FIG. 1).

According to some demonstrative embodiments of the invention, signal discrimination device 200 may also include a first multiplexer 203, a second multiplexer 204, and a signal adjustment module 207, as are described in detail below. In some demonstrative embodiments signal adjustment module 207 may include, and/or may be, for example, a compensator.

Some demonstrative embodiments of the invention may refer to a signal discrimination device, e.g., device 200, including signal adjustment module, e.g., module 207, which includes, for example, a compensator able to compensate a response of a legacy frequency signal of a legacy frequency band. The compensator may be referred to herein as a “legacy compensator”. However, it will be appreciated by those of ordinary skill in the art that other embodiments of the invention may include a signal discrimination device including, in addition to or instead of the legacy compensator, any other suitable signal adjustment module, e.g., a filter able to filter the legacy frequency signal. The filter may be referred to herein as a “legacy filter”. The legacy frequency band may include a legacy downstream frequency band and a legacy upstream frequency band, as are described in detail below.

According to some demonstrative embodiments of the invention, multiplexer 203 may selectively route a legacy frequency signal of a legacy frequency band, e.g., a frequency band of about 5-860 MHz, and/or a single-phase AC power signal, e.g., having a frequency of about 50-60 Hz, from terminal 201 to module 207. Module 207 may generate a compensated legacy frequency signal corresponding to the legacy frequency signal. Multiplexer 204 may route the compensated legacy frequency signal from module 207 to terminal 202.

According to some demonstrative embodiments of the invention, multiplexer 203 may selectively route a signal of an extend frequency band, e.g., a frequency band of about 1250-2950 MHz, from terminal 201 to multiplexer 204, e.g., with minimal and/or possibly flat insertion loss. Alternatively, module 200 may include any suitable configuration for passing the extended frequency signal from multiplexer 203 to multiplexer 204. Multiplexer 204 may then route the extended frequency signal from multiplexer 204 to terminal 202.

According to some demonstrative embodiments of the invention and as a non-limiting example of implementations, multiplexer 203 may include a diplexer. Multiplexer 203 may include, for example, a low-pass filter (LPF) 210 able to selectively transfer signals of the legacy frequency band, and/or an AC power signal, from terminal 201 to module 207. Multiplexer 203 may also include a high-pass filter (HPF) 220 able to selectively transfer signals of the extended frequency band, from terminal 201 to multiplexer 204. Multiplexer 204 may include a diplexer. Multiplexer 204 may include, for example, a low-pass filter 211 to selectively transfer the legacy frequency signals, and/or the AC power signal, from module 207 to terminal 202. Multiplexer 204 may also include a high-pass filter 221 to selectively transfer the extended frequency signals to terminal 202.

According to some demonstrative embodiments of the invention, signal adjustment module 207 may be adapted to generate an adjusted signal corresponding to the legacy frequency signal. Signal adjustment module 207 may include, for example, an equalizer 280. Equalizer 280 may include any suitable equalizer, for example, a plug in equalizer, adapted to compensate for a frequency response slope due to losses of transmission cables, e.g., coaxial cables. Such transmission losses may be experienced, for example, by signals in the legacy downstream frequency band, e.g., in a bandwidth of about 52-860 MHz (also referred to herein as “legacy downstream signals”). Equalizer 280 may provide loss adjustment to the legacy downstream signals, for example, to control the spectrum shape of signals due to inherent attenuation slope of transmission cables, e.g., cables 131-135 (FIG. 1). Module 207 may additionally or alternatively include an attenuator 270, adapted to provide a predetermined amount of insertion loss to signals in the legacy upstream frequency band, for example, in a bandwidth of about 5-42 MHz (also referred to herein as “legacy upstream signals”). Attenuator 270 may include any suitable attenuator, e.g., a variable attenuator as is known in the art. Attenuator 270 may provide a predetermined amount of insertion loss to the legacy upstream signals. Attenuator 270 may be utilized, for example, to overcome noises by attenuating the overall upstream signal spectrum. This may result, for example, in subscribers increasing their upstream transmitter power thereby to overcome noises which may exist within frequencies of about 5-42 MHz, e.g., at the subscriber end.

According to some demonstrative embodiments of the invention, module 207 may further include an AC signal path 232, which may include, for example, one or more RF chokes, e.g., chokes 230 and 231. AC signal path 232, together with chokes 230 and 231, may be able to by-pass the energy of an AC signal, e.g., a single phase AC signal, from terminal 201 to terminal 202.

According to some demonstrative embodiments of the invention, module 207 may also include a multiplexer 205 to route the legacy downstream signals of the legacy downstream frequency band from multiplexer 203 to equalizer 280. Module 207 may also include a multiplexer 206 to selectively route equalized legacy downstream signals from equalizer 280 to multiplexer 204. Multiplexer 206 may also selectively route legacy upstream signals of the legacy upstream frequency band from multiplexer 204 to attenuator 270; and multiplexer 205 may route attenuated legacy upstream signals from attenuator 270 to multiplexer 203.

According to demonstrative embodiments of the invention and as a non-limiting example of implementation, multiplexer 205 may include a low-pass filter 240 to route or transfer the legacy upstream signals; and a high-pass filter 250 to route or transfer the legacy downstream signals. Multiplexer 206 may include a low-pass filter 241 to route or transfer the legacy upstream signals; and a high-pass filter 251 to route or transfer the legacy downstream signals.

In a non-limiting demonstrative embodiment, module 207 may include or may be a multimedia line equalizer/reverse conditioner 870 MHz-42/51 MHz Split, part number 714413 Rev D, December 2003, manufactured by Scientific Atlanta, Inc.

In another non-limiting demonstrative embodiment, module 207 may include or may be a feeder line equalizer model FFE-8-87S/RP, FFE-8-75S/RP or FFE-HSG/87S/RP manufactured by Motorola, Inc.

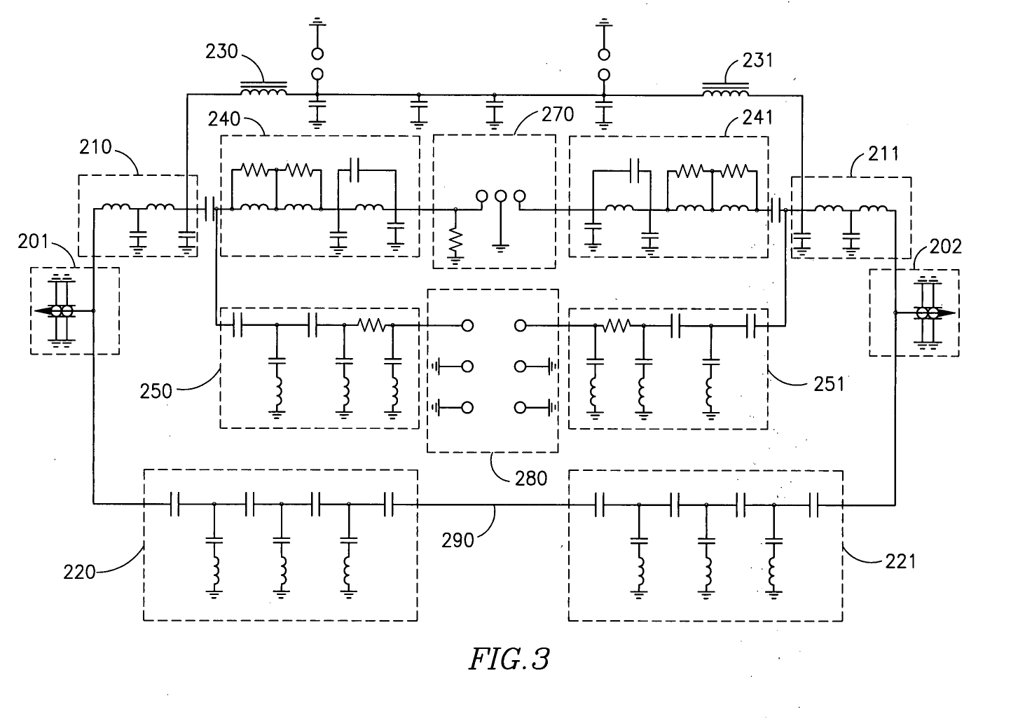

FIG. 3 is a non-limiting example of a wiring diagram of circuitry of device 200. Like numerals in FIG. 3 refer to the same block elements in FIG. 2. FIG. 3 illustrates how some of the elements in device 200 may be implemented by using capacitors and inductors with the appropriate capacitance and inductance. It will be appreciated by a person skilled in the art that the particular embodiment shown in FIG. 3, for example, the particular capacitance and inductance values for some of the elements used in device 200, may represent only one of many possible implementations for the block diagram shown in FIG. 2.

It will be appreciated by person skilled in the art that the above description of FIG. 2 and FIG. 3 applies to signals across the wide frequency band and propagating from terminal point 201 to terminal point 202, or from terminal point 202 to terminal point 201. In addition, legacy frequency signals and extended frequency signals may propagate separately and independently. Also, legacy upstream signals may propagate separately and independently from legacy downstream signals. For example, legacy upstream signal may propagate in opposite direction to legacy downstream signals. In other words, wideband compensation module 200 may be a bi-directional device. In the above description, the term “upstream” and “downstream” are all relative, and may be used to mean either direction. In addition, the extended frequency signals may include an extended upstream signal and/or an extended downstream signal. The legacy downstream signals and extended downstream signals may be part of an extended bandwidth downstream signal, and the legacy upstream signals and extended upstream signals may be part of an extended bandwidth upstream signal.

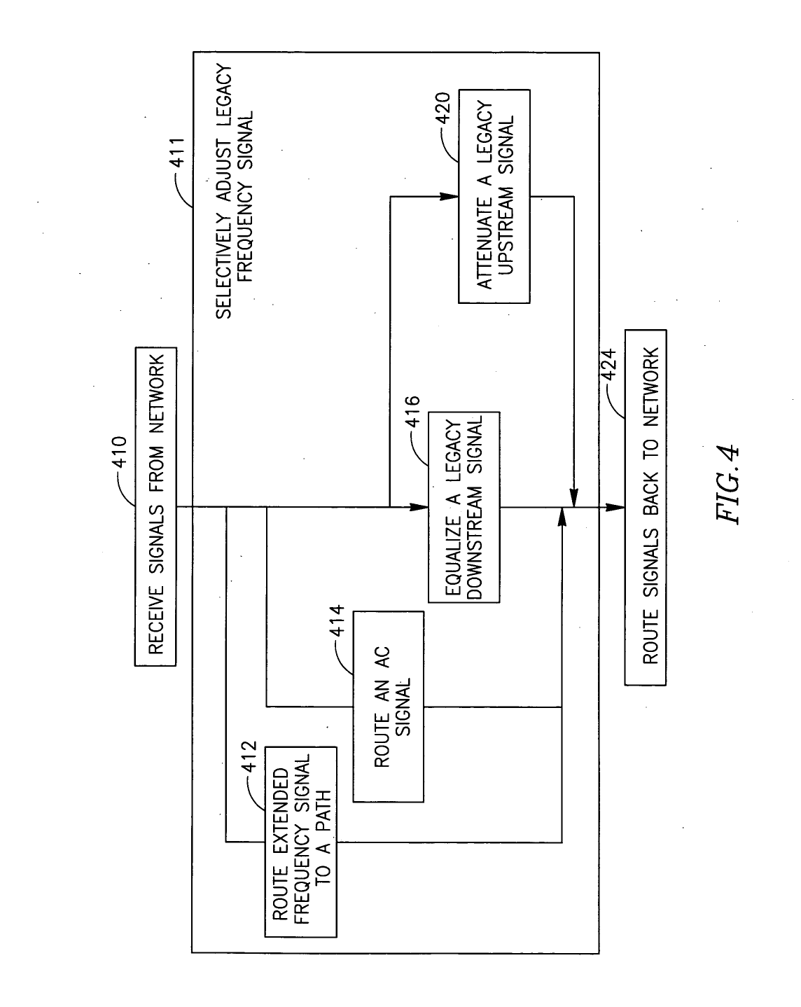

FIG. 4 is a schematic flowchart of a method of discriminately handling a wideband transmission of a cable communication network in accordance with some demonstrative embodiments of the invention.

As indicated at block 410, according to some demonstrative embodiments of the invention the method may include receiving a wideband transmission from a wideband CATV network. Receiving the wideband transmission may include, for example, receiving a wideband transmission including a legacy frequency signal and an extended frequency signal. The wideband transmission may be received, for example, by a first terminal, e.g., terminal 201 (FIG. 2), of a signal discrimination device, e.g., device 200 (FIG. 2).

As indicated at block 411, the method may include selectively adjusting the legacy frequency signal to generate an adjusted legacy frequency signal.

As indicated at block 412, selectively adjusting the legacy frequency signal may include selectively routing the extended frequency signal to a predetermined path, e.g., including a pass-through connection. Selectively routing the extended frequency signal may include, for example, routing the extended frequency signal from the first terminal to a second terminal, e.g., terminal 202 (FIG. 2), of the signal discrimination device. Selectively routing the extended frequency signal may include, for example, routing the extended frequency signal with flat and/or minimal insertion loss.

As indicated at block 414, selectively adjusting the legacy frequency signal may also include using one or more RF chokes to route an AC signal, for example, a single phase AC signal, e.g., as described above with reference to FIG. 2. The method may also include routing the AC signal back to the network, as indicated at block 424.

As indicated at block 416, selectively adjusting the legacy frequency signal may also include equalizing a legacy downstream signal to generate an equalized downstream signal. Equalizing the legacy downstream signal may include, for example, routing the legacy downstream signal to an equalizer, e.g., as described above with reference to FIG. 2. The method may also include routing the equalized downstream signal back to the network, as indicated at block 424.

As indicated at block 420, selectively adjusting the legacy frequency signal may also include attenuating a legacy upstream signal to generate an attenuated upstream signal. Attenuating the legacy upstream signal may include, for example, routing the legacy upstream signal to an attenuator, e.g., as described above with reference to FIG. 2. The method may also include routing the attenuated upstream signal back to the network, as indicated at block 424.

Embodiments of the present invention may be implemented by software, by hardware, or by any combination of software and/or hardware as may be suitable for specific applications or in accordance with specific design requirements. Embodiments of the present invention may include units and sub-units, which may be separate of each other or combined together, in whole or in part, and may be implemented using specific, multi-purpose or general processors, or devices as are known in the art. Some embodiments of the present invention may include buffers, registers, storage units and/or memory units, for temporary or long-term storage of data and/or in order to facilitate the operation of a specific embodiment

While certain features of the invention have been illustrated and described herein, many modifications, substitutions, changes, and equivalents may occur to those of ordinary skill in the art. It is, therefore, to be understood that the appended claims are intended to cover all such modifications and changes as fall within the true spirit of the invention.

What is claimed is:

1. A signal discrimination device for discriminately handling a wideband transmission including a legacy frequency signal of a legacy frequency band and an extended frequency signal of an extended frequency band, the signal discrimination device comprising:
first and second terminals;
a signal adjustment module to generate an adjusted signal corresponding to said legacy frequency signal;
a first multiplexer to route said legacy frequency signal from said first terminal to said signal adjustment module; and
a second multiplexer to route said adjusted signal to said second terminal, wherein said first multiplexer is able to route said extended frequency signal of said extended frequency band from said first terminal to said second multiplexer, and wherein said second multiplexer is able to route said extended frequency signal to said second terminal.

2. The signal discrimination device of claim 1, wherein said first multiplexer is able to route an AC power signal from said first terminal to said signal adjustment module, wherein said signal adjustment module comprises one or more RF chokes to selectively route said AC power signal to said second multiplexer, and wherein said second multiplexer is able to route said AC power signal from said signal adjustment module to said second terminal.

3. The signal discrimination device of claim 1, wherein at least one of said first and second multiplexers comprises:
a low-pass filter to selectively transfer said legacy frequency signal; and
a high-pass filter to selectively transfer said extended frequency signal.

4. The signal discrimination device of claim 3, wherein said low-pass filter is able to transfer a signal of a frequency of 860 MHz or less, and wherein said high-pass filter is able to transfer a signal of a frequency of at least 1250 MHz.

5. The signal discrimination device of claim 1, wherein said signal adjustment module comprises a compensator to compensate a power of said legacy frequency signal.

6. The signal discrimination device of claim 5, wherein said compensator comprises:
an equalizer to generate an equalized downstream signal corresponding to a legacy downstream signal of said legacy frequency band;
an attenuator to generate an attenuated upstream signal corresponding to a legacy upstream signal of said legacy frequency band;
a third multiplexer to route said legacy downstream signal from said first multiplexer to said equalizer, and to route said attenuated upstream signal from said attenuator to said first multiplexer; and
a fourth multiplexer to route said equalized downstream signal from said equalizer to said second multiplexer, and to route said legacy upstream signal from said second multiplexer to said attenuator.

7. The signal discrimination device of claim 6, wherein at least one of said third and fourth multiplexers comprises:
a low-pass filter to selectively transfer said legacy upstream signal; and
a high-pass filter to selectively transfer said legacy downstream signal.

8. The signal discrimination device of claim 7, wherein said low-pass filter is able to transfer a signal of a frequency of between about 5 and 42 MHz; and wherein said high-pass filter is able to transfer a signal of a frequency of between about 52 and 860 MHz.

9. The signal discrimination device of claim 5, wherein said compensator comprises:
an equalizer to generate an equalized downstream signal corresponding to a legacy downstream signal of said legacy frequency band;
a third multiplexer to route said legacy downstream signal from said first multiplexer to said equalizer; and
a fourth multiplexer to route said equalized downstream signal from said equalizer to said second multiplexer.

10. The signal discrimination device of claim 5, wherein said compensator comprises:
an attenuator to generate an attenuated upstream signal corresponding to a legacy upstream signal of said legacy frequency band;
a third multiplexer to route said attenuated upstream signal from said attenuator to said first multiplexer; and
a fourth multiplexer to route said legacy upstream signal from said second multiplexer to said attenuator.

11. The signal discrimination device of claim 1, wherein said signal adjustment module comprises a filter to filter said legacy frequency signal.

12. A wideband cable television network supporting a legacy frequency band and an extended frequency band, the network comprising:
a signal discrimination device including:
a signal adjustment module to generate an adjusted signal corresponding to a legacy frequency signal of said legacy frequency band;
a first multiplexer to route said legacy frequency signal from a first terminal of said signal discrimination device to said signal adjustment module; and
a second multiplexer to route said adjusted signal to a second terminal of said signal discrimination device,
wherein said first multiplexer is able to route an extended frequency signal of said extended frequency band from said first terminal to said second multiplexer, and wherein said second multiplexer is able to route said extended frequency signal to said second terminal; and
at least one transmission cable to transfer said legacy frequency signal to said signal discrimination device.

13. The wideband cable television network of claim 12, wherein at least one of said first and second multiplexers comprises:
a low-pass filter to selectively transfer said legacy frequency signal; and
a high-pass filter to selectively transfer said extended frequency signal.

14. The wideband cable television network of claim 12, wherein said signal adjustment module comprises a compensator to compensate a power of said legacy frequency signal.

15. The wideband cable television network of claim 14, wherein said compensator comprises:
an equalizer to generate an equalized downstream signal corresponding to a legacy downstream signal of said legacy frequency band;
an attenuator to generate an attenuated upstream signal corresponding to a legacy upstream signal of said legacy frequency band;
a third multiplexer to route said legacy downstream signal from said first multiplexer to said equalizer, and to route said attenuated upstream signal from said attenuator to said first multiplexer; and
a fourth multiplexer to route said equalized downstream signal from said equalizer to said second multiplexer, and to route said legacy upstream signal from said second multiplexer to said attenuator.

16. The wideband cable television network of claim 12, wherein at least one of said third and fourth multiplexers comprises:
a low-pass filter to selectively transfer said legacy upstream signal; and
a high-pass filter to selectively transfer said legacy downstream signal.

17. A method of discriminately handling a wideband transmission of a cable communication network, the transmission including a legacy frequency signal of a legacy frequency band and an extended frequency signal of an extended frequency band, the method comprising:
receiving said wideband transmission;
selectively adjusting said legacy frequency signal to generate an adjusted legacy frequency signal; and
routing said adjusted legacy frequency signal and said extended frequency signal to said network.

18. The method of claim 17, wherein selectively adjusting said legacy frequency signal comprises selectively routing said legacy frequency signal to a signal adjustment module.

19. The method of claim 17, comprising:
selectively transferring said legacy frequency signal through a low-pass filter; and
selectively transferring said extended frequency signal through a high-pass filter.

20. The method of claim 17, wherein selectively adjusting said legacy frequency signal comprises:
equalizing a legacy downstream signal of said legacy frequency band to generate an equalized downstream signal; and
attenuating a legacy upstream signal of said legacy frequency band to generate an attenuated upstream signal.

21. The method of claim 20, comprising:
selectively transferring said legacy upstream signal through a low-pass filter; and
selectively transferring said legacy downstream signal through a high-pass filter.
